(19) United States
(12) Patent Application Publication
(10) Pub. No.: US 2003/0058991 A1
(43) Pub. Date: Mar. 27, 2003

(54) Digital radioscopic testing system patent

(76) Inventor: Paul Lott, Anchorage, AK (US)

Correspondence Address: Paul Lott, P.O. Box 200233, Anchorage, AK, 99520, US

(21) Appl. No.: 09/960,773

(22) Filed: Sep. 24, 2001

(51) Int. Cl. G01N 23/02

(52) U.S. Cl. 378/60

(57) ABSTRACT

This is a system developed to inspect, interpret and evaluate welds on pipelines. It combines several different existing technologies into one powerful tool. The Digital Radioscopic Testing System combines an internal radiographic source mounted on an internal pipeline crawler, with a camera that is mounted on an external crawler that travels around the circumference of a pipe capturing a digital image of the weld. The digital image of the weld is transmitted to a personal computer with scanning software that can process, display, measure and enhance the image. Finally, the images are annotated and archived together with pertinent reporting data into one seamless, archived database for ease of storage and auditing.

### 1. FIELD OF INVENTION

Industry=Nondestructive Evaluation (NDE)

Product Group=Pipeline Girth Weld Inspection—New Construction

The NDE industry locates discontinuities and assesses flaws beneath the surface of a building, bridge, pipeline or other structure. Since 1995, the advancement of NDE tools have changed dramatically, enabling engineers to rapidly evaluate a wide range of defects with little disturbance to the users or the structure.

For the past 40 years, NDE pipeline girth weld inspections have been conducted using film radiography. Within the last 10 years, ultrasonic inspections have also proven to be successful as an alternative method.

The future growth area of pipeline girth inspection is using filmless radioscopy based upon Digital Radioscopic Testing.

Digital Radioscopic Testing is our solution to the NDE pipeline girth inspection process. Our technique can be used in new on/off shore pipeline construction and is a system that combines digital radiography techniques and internal and external pipeline crawler robots.

### 2. BACKGROUND OF INVENTION

Film Radiography Inspection System Today

The Film Radiography Inspection System (FRIS) is the most traditional NDE inspection method used for new pipeline construction. The FRIS has been the only acceptable quality control inspection process since the 1950s. This system is used on approximately 90% of new pipeline construction projects. More than 90% of the welds inspected by film radiography are welds created by hand, not machine. The exposed film is read and interpreted by a level II certified radiographer. The results are documented and archived with the developed film.

The FRIS is a time-intensive process and takes up to 24 hours to complete (e.g. expose, develop, interpret and document a series of welds). For example, a technician may expose 10 welds per day, but after the welds have been exposed, the film must be developed, interpreted, the results documented, and the findings reported the following day; therefore, creating a 24-hour process. This 24-hour delay in the weld inspection has two large impacts on the pipeline construction crew:

Waiting on inspection results may impact the cost and schedule of a construction project.

Proceeding without the inspection results will expose the pipeline builder to costly repair.

Ideally, girth weld inspection time should be able to keep pace with the pipeline welding process—it estimated that a 6-minute inspection process would be optimal. Film radiography could only accomplish this 6-minute examination process per weld if the technology allowed them to expose the weld and read the results instantaneously.

Problem: The radiographic inspection process is too segmented and lengthy. It impacts the speed and cost of new pipeline construction.

Solution: The ideal inspection process would combine the film exposure and image reading into one overlapping time frame: digital radioscopy.

Ultrasonic Inspection System Today

For several years now, the Ultrasonic Inspection system has been used as a nondestructive testing method to evaluate the integrity of automatic welded girth welds. This is an automated process that relies on analog/digital technology and a specialized technician.

This process is rapid, but it has only been proven to be reliable if the welds are done by automatic welding. If a machine creates a weld, then the structure of the weld is the same for each weld; therefore, untrasonics will detect flaws much more easily. If the welds are done manually, the welds will vary in structure and the inspection results based upon an ultrasonic system becomes less reliable.

With automated ultrasonics, there are no readily understandable inspection results that the owner/contractor can review to evaluate the level II technician's decision. In other words, there are no pictures that document the technician's inspection results. The technician must have a specialized certification in ultrasonic technology and must understand the results.

Problem: The ultrasonic inspection process is difficult to understand and is operator dependent—inspection documentation is not easily evaluated, and it does not tolerate manual welds. Approximately 90% of all new pipeline construction welds are done manually.

Solution: The ideal ultrasonic inspection system would have visible inspection results that could be viewed and evaluated by the owner/contractor—someone other than the specialized technician, and would be more tolerate of manual welds.

### 3. DESCRIPTION OF PRIOR ART

Film Radiography Inspection System Today

This system has the following elements and was never patented:

1. Internal/external radiation source

2. Film

3. Number belt containing IQIs, shims and lead numbers for weld location and identification.

4. Image quality indicator

5. Film processing chemicals

6. Light box (film viewer)

7. Film flash for weld identification.

There are two traditional methods to conduct film radiography on a girth weld:

Single wall exposure with the radiation source inside the pipe and film on the outside

Double wall exposure with both the source and film outside of the pipe and opposite each other.

The usual procedure is to place the x-ray source inside the pipe and wrap the outside of the weld with film. The x-ray source emits a 360-degree panoramic bean so the entire weld is exposed in a single exposure. The film is then developed and read by a radiographer for weld quality assessment. The current processing time is a follows:

Exposure time varies from seconds to hours depending on the wall thickness, pipe diameter and the radiographic technique used.

15-20 minutes for film development

5 minutes for reading

5 minutes to document results

The total elapsed time for inspection results, when conducted in the field during new pipeline construction is frequently 24 hours because film exposure, developing and reporting are all separate events that usually take place at different locations. It is not an integrated process.

Ultrasonic Inspection System

This system has the following elements and was never patented:

1. Motorized carrier—pipeline exterior

2. Ultrasonic transducers

3. Printer—multichannel strip chart output

4. Computerized Acquisition Unit

5. Couplant (usually water)

For the purpose of defect identification and Engineering Critical Assessment (ECA) the weld is divided into several zones. Each zone covers about 2 mm of thickness of the weld. Ultrasonic transducers are designed and positioned to investigate each zone from both sides of the weld centreline. The array of probes is moved around the girth weld by a motorized carrier which travels along the same track the welding apparatus uses. Signals received by the ultrasonic instruments are monitored by electronic gates and both amplitude of signal and its time of arrival (the point where the signal interrupts the gate) can be collected. The weld region is monitored from just before the design fusion line to just after the weld centerline. The gated output is usually digitized and then displayed for evaluation by the operator. In some cases a computer monitor is the display on which the evaluations are made while in others it is a multi-channel strip chart which is evaluated.

In evaluating the scan results the operator makes a decision as to weld acceptability based on the length and amplitude of a signal exceeding a threshold as set out in the company specification.

### 4. SUMMARY OF THE INVENTION—DIGITAL RADIOSCOPY TESTING SYSTEM

The Digital Radioscopy Testing System (DRTS) consists of the following technologies:

1. Internal Pipeline Crawler—Radiation Source

2. Digital Linear Array Detector—X-Ray Camera

3. External Pipeline Crawler

4. Analog/Digital Converter Circuit

5. Scanning Software with image processing and measurement capabilities

6. Personal Computer

7. Computer Keyboard

8. Computer Mouse

9. Color LCD Computer Monitor

10. Number belt

11. Image quality indicator

12. Database Management Software with reporting capabilities.

Internal Pipeline Crawler—Radiation Source

The internal pipeline crawler is the radiation source for the radioscopic process. This is a remote control unit that travels down the pipeline upon demand.

The units are designed and proven for both onshore and offshore to work as fully self-contained, self-powered exposure vehicles. There are no trailing leads and all commands whilst in the pipeline are executed from outside, using a low-activity isotope. The units can be commanded to travel, stop, and radiograph as required.

Full remote control of travel, park and exposure modes are carried out from the outside of the pipeline. By means of a small (20 millicurie caesium 137) control isotope, with a positioning accuracy of up to ±2 mm, control information is received by a detector box and converted to operate the crawler. A non-isotope remote controller system may be used in lieu of an isotope controller.

Digital Linear Array Detector—X-Ray Camera

The X-Ray Camera is connected to the External Pipeline Crawler.

The maximum resolution of the X-Ray Camera is 12 pixel/mm. Cameras are available in standard lengths of 160, 320, 480 and 640 mm, non-standard lengths can be manufactured. The camera comes in a compact insulated metal casing, which ensures protection from hostile industrial environment. The camera has a florescent screen on the outside of the linear array or it can be imbedded inside the linear array.

External Pipeline Crawler

The External Pipeline Crawler is a motorized carrier for the x-ray camera. It is mounted on the exterior of the pipeline next to the girth weld. This crawler carries the x-ray camera around the circumference of the pipe. It also provides a power source and transportation for the x-ray camera.

Analog/Digital Signal Converter Circuit

The Analog/Digital Signal Converter Circuit is an interface card that digitalizes the analog image data being sent from the x-ray camera(12 Bit=4096 grey levels). This data is transmitted via the PCI or ISA bus to be processed on the PC. Up to three cameras can be connected to one PCI interface card. Through that it is possible to inspect three different areas at the same time, or to have three different views of the same test part.

Scanning Software

The x-ray imaging software (DOS, Windows NT compatible) consists of two interrelated programs which control the scanning and the image processing steps respectively.

The scanning software controls the image acquisition. The object is imaged on screen as the scanning progresses. The image is then processed with the specifically designed x-ray imaging software. The entire x-ray image as well as a detail window (with various zoom settings) will be shown on the same display, so even extreme magnifications do not disturb surveying the whole screen.

The Software includes a range of variable image enhancing functions. Image halftones, brightness etc., are easily altered to intensify detail in the x-ray image. Any adjustment of image information is immediately visible on screen. Optimal image settings for a particular image may be saved and applied later to other x-ray images.

Interactive on screen functions, i.e. measurement, image inversion, application of pseudo-color, copying of windows etc., can be performed. The software, which is controlled using a keyboard and mouse can be customized to satisfy specialized requirements. Images are stored in GIF file format, which is compatible with other graphic software.

Scanning velocities and exposure times are variable to suit the application. The maximum scan speed depends on the required resolution and the applied interface card (PCI or ISA). The scanning velocity of the linear array is controlled by the integration time setting in the scanning software.

Personal Computer

The principal characteristics of a personal computer is that it is single-user system and is based on a microprocessor. Currently the operating system used in this system is Microsoft Windows NT. No specific model is specified because the Personal Computer will be updated as technology improves, as will the operating system and other software.

Computer Keyboard

The set of typewriter-like keys that enables you to enter data into the personal computer. Computer keyboards are similar to electric-typewriter keyboards but contain additional keys.

Computer Mouse

A device that controls the movement of the cursor or pointer on the computer monitor display. Its name is derived from its shape, which looks a bit like a mouse, its connecting wire that one can imagine to be the mouse's tail, and the fact that one must make it scurry along a surface. As you move the mouse, the pointer on the display screen moves in the same direction. The mouse contains at least one button and sometimes as many as three, which have different functions depending on the software. Some newer mice also include a scroll wheel for scrolling through long documents.

Color LCD Computer Monitor

A computer monitor that uses LCD technologies rather than the conventional CRT technologies used by most desktop monitors. Until recently, LCD panels were used exclusively on portable computers and other portable devices. In 1997, however, several manufacturers began offering full-size LCD monitors as alternatives to CRT monitors. The main advantage of LCD displays is that they take up less desk space and are lighter.

LCD (Liquid Crystal Display): a type of display used in digital watches and many portable computers. LCD displays utilize two sheets of polarizing material with a liquid crystal solution between them. An electric current passed through the liquid causes the crystals to align so that light cannot pass through them. Each crystal, therefore, is like a shutter, either allowing light to pass through or blocking the light. The color LCD display is passive matrix using new CSTN and DSTN technologies produce sharp colors rivaling active-matrix displays.

Passive Matrix: A common type of flat-panel display consisting of a grid of horizontal and vertical wires. At the intersection of each grid is an LCD element which constitutes a single pixel, either letting light through or blocking it.

CSTN (Color Super-Twist Nematic): an LCD technology developed by Sharp Electronics Corporation. CSTN is based on a passive matrix. The original CSTN displays developed in the early 90's suffered from slow response times and ghosting. New CSTN displays offer 100 ms response times, a 140 degree viewing angle, and high-quality color rivaling TFT displays—all at about half the cost.

DSTN (Double-layer Supertwist Nematic): A passive-matrix LCD technology that uses two display layers to counteract the color shifting that occurs with conventional CRT displays.

CRT (Cathode-Ray Tube): the technology used in most televisions and computer display screens. A CRT works by moving an electron beam back and forth across the back of the screen. Each time the beam makes a pass across the screen, it lights up phosphor dots on the inside of the glass tube, thereby illuminating the active portions of the screen. By drawing many such lines from the top to the bottom of the screen, it creates an entire screen full of images.

Number Belt

The Number Belt is made of flexible material and contains lead numbers. The numbers are sequential and are equally spaced to reflect either inches or centimeters for measurement location purposes. This belt is wrapped around the girth of the pipe next to the weld and is scanned by the x-ray camera. This belt is used to permanently identify the weld and any weld defect location in the pipe girth weld. The belt is also used to retain the penetrameter in place. The penetrameter is used to assess image quality.

A hash mark made on the pipe indicates the start of the number sequence on the number belt. Next to the hash mark is an arrow indicating the direction of the number sequence. The number belt is used during a weld scan, removed once the scan is complete, and then re-used on another weld.

Image Quality Indicator

To ensure this system complies with the American Petroleum Institute API1104 standard for weld radiographic quality, a hole type Image Quality Indicator (IQI) is used during the weld scan. The IQI used in this system is the penetrameter. Each penetrameter has three holes: 1T, 2T, and 4T. The size of these holes reflects the thickness of the penetrameter. For example, the 1T hole is 1 times the thickness of the penetrameter; the 2T hole is 2 times the thickness of the penetrameter; and the 4T hole is 4 times the thickness of the penetrameter. The penetrameter thickness will vary according to pipe thickness. For example, IQI quality level 2-2T means that the IQI thickness “T” is 2% of the specimen thickness, and the diameter of the IQI imaged hole is 2 times the IQI thickness.

According to API 1104, you must be able to see the 2T hole on the penetrameter in the radioscopic image for the image scanning to meet inspection code. If you can see the 2T hole, then the radiographer will be able to determine if there is a faulty weld. Wire image quality indicators may be used to indicate the quality of radioscopic images in lieu of the hole type IQI.

### 5. BRIEF DESCRIPTION OF THE DRAWINGS

FIG. 1: The System Overview

FIG. 1 is a pictorial view of the entire system as it is being used in the field during new pipeline construction.

FIG. 2: Semiconductor Array with Fluorescence

FIG. 2 is a pictorial view of the array technology implemented by the x-ray camera, specifically an x-tray camera with a fluorescent screen on the exterior of the semiconductor array.

FIG. 3: Configuration for Number Belt & Image Quality Indicator (IQI)

FIG. 3 is a pictorial view of the Number Belt and IQI location relative to the pipe weld as seen from a cross-section of the pipe and then from a top view of the pipe.

### 6. DETAILED DESCRIPTION OF DRAWINGS

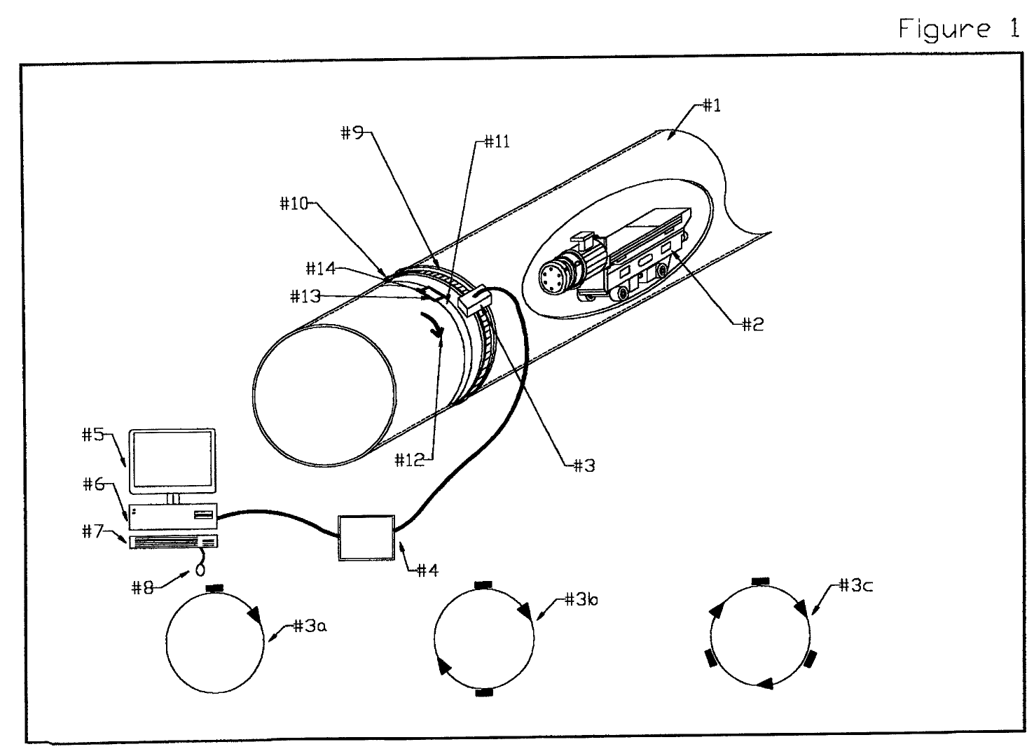

FIG. 1: The System Overview

During new pipeline construction, pipes are welded together to create the pipeline. Our system inspects the pipeline girth welds that connect two pipes. Once the weld is completed, the inspection team performs the following tasks:

Step 1. Place the number belt and penetrameter on the outside circumference of the pipe, next to the weld.

Step 2. Place the internal pipeline crawler (radiation source) inside the pipe.

Step 3. The internal pipeline crawler is a remote control device and is placed under the weld.

Step 4. A hash mark and arrow is written on the pipe to indicate the staring place of the number belt and the direction of the numbers.

Step 5. The external pipeline crawler and x-ray camera are then mounted on the outside circumference of the pipe.

Step 6. The inspection crew steps away from the pipe.

Step 7. The internal crawler radiation source is activated

Step 8. The scanning software initiates the scan

Step 9. Once scan is complete, the radiation source is turned off

Step 10. The scan results in a display of the weld radioscopic image on the computer monitor

Step 11. The radiographer evaluates the weld from the images on the computer screen.

Step 12. The radioscopic image and its inspection results are archived on a CD-ROM, DVD or similar electronic storage medium.

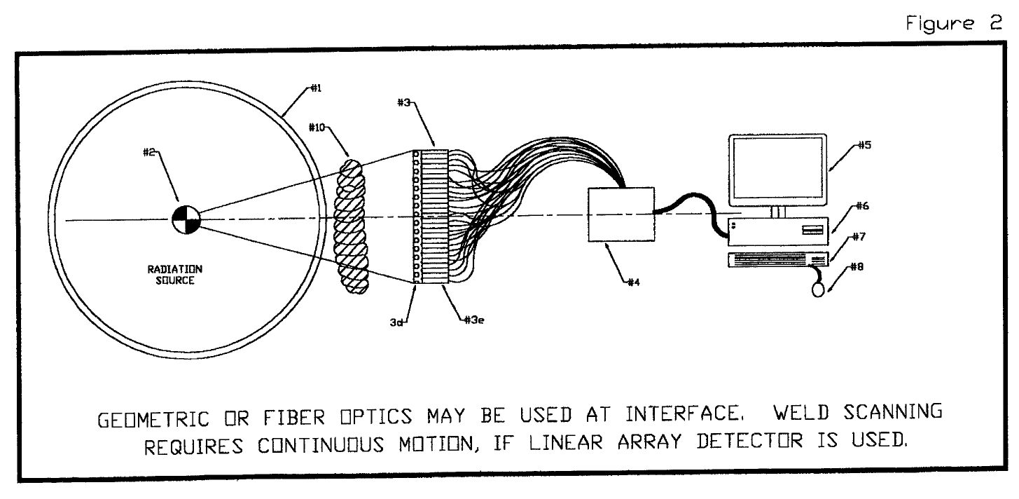

FIG. 2: Semiconductor Array with Fluorescence

FIG. 2 is a pictorial view of the array technology implemented by the x-ray camera, specifically an x-tray camera with a fluorescent screen on the exterior of the camera Weld scanning requires continuous motion if linear array detector (x-ray camera) is used.

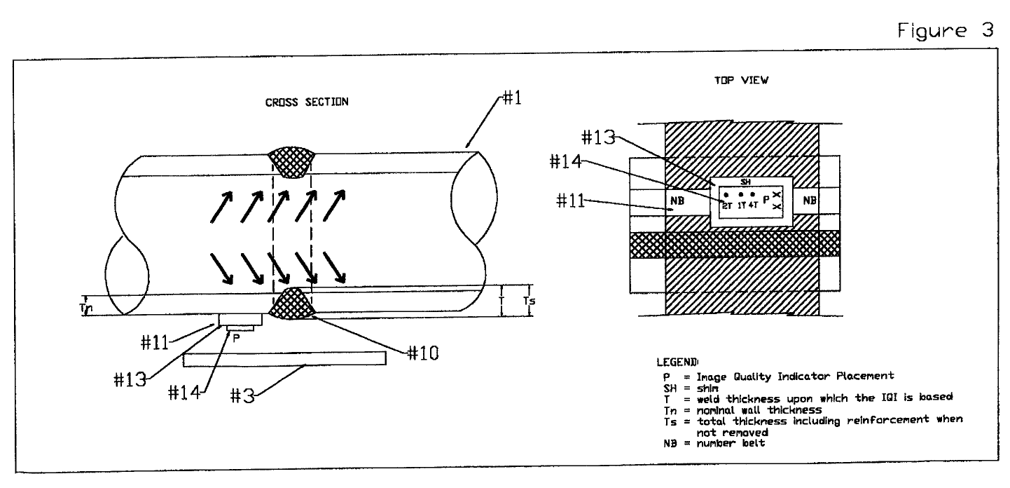

FIG. 3: Configuration for Number Belt & Image Quality Indicator (IQI)

Placing the number belt and penetrameter adjacent to the weld is a very important step in this system. The following steps must be made to ensure the weld inspection is done correctly.

Step 1. Each girth weld has a “cap”, or weld reinforcement. This cap makes the weld raised above the outside of the pipe. To ensure the radiography meets code, the IQI (penetrameter) needs to be the same height as the weld. To raise the penetrameter, a shim is used. The size of the shim will be determined by the weld configuration. For this step in the system, the proper shim is identified for use.

Step 2. Determine the correct penetrameter. The size of the penetrameter is determined by the pipe thickness. This should be determined before going to the field.

Step 3. Place the shim under the penetrameter.

Step 4. Place the three sets of the shim+penetrameter combination on the number belt.

Step 5. Place the number belt adjacent to the weld and around the circumference of the pipe.

Step 6. Make a hash mark and arrow on the pipe indicating the starting of the number sequence on the number belt and the direction of the numbers on the number belt

Step 7. Once the scan is complete the radiographer is reviewing the image, it is very important that the “2T” hole on the penetrameter is visible in the image. If it is distinguishable, then the scan meets industry code.

7. Invention Nomenclature

1—The Pipeline

2—The Radiation Source, the Internal Pipeline Crawler

3—The X-Ray Camera, the Linear Array Detector

3a—Single X-Ray Camera configuration

3b—Double X-Ray Camera configuration

3c—Triple X-Ray Camera configuration

3d—Fluorescent Screen on X-Ray Camera

3e—Diode Array

4—Analog/Digital Signal Circuit Converter

5—Computer Monitor

6—Personal Computer

7—Computer Keyboard

8—Computer Mouse

9—External Pipeline Crawler

10—Pipeline Girth Weld

11—The Number Belt

12—The hash mark and directional arrow

13—Shim

14—IQI device, the penetrameter

8. Drawings: FIGS. 1,2 & 3 follow.

What is claimed is:

1) The Digital Radioscopic Testing System is the only direct digital radioscopy system used in pipeline construction girth weld inspection. This system combines the following:
A) An internal pipeline crawler subsystem with a radiographic source.
B) An external pipeline crawler subsystem with a track around the pipeline's circumference.
C) A camera that captures the digital x-ray image.
D) A computer subsystem that has the software necessary to scan, display, interpret, measure, manipulate, store, archive, and manage the image data.

2) The claim in 1. which includes both a wired or a wireless transmission of data from the camera mounted on the external crawler to the personal computer.

3) The claim in 1. which includes both an internal (single wall) x-ray generating source, and an external (double wall) x-ray generating source.

4) The claim in 1. which includes both a powered external crawler and an unpowered external crawler.

5) The claim in 1. which includes both a powered internal crawler and an unpowered internal crawler.

6) The claim in 1. which includes an internal crawler that is guided both with an isotope controller and a non-isotope controller.

7) The claim in 1. which includes both an internal or external power source for either or both of the internal and/or external crawler subsystems.

8) The claim in 1. which includes both a tracked external crawler and a trackless external crawler.

9) The claim in 1. which includes both onshore and offshore pipeline construction.

10) The claim in 1. which includes both new construction and corrosion inspection.
